(19) United States
(12) Patent Application Publication
(10) Pub. No.: US 2019/0370872 A1
(43) Pub. Date: Dec. 5, 2019

(54) CUSTOM DOOR DESIGN SYSTEM

(71) Applicant: Jorge Quiceno, Brampton (CA)

(72) Inventor: Jorge Quiceno, Brampton (CA)

(21) Appl. No.: 15/991,200

(22) Filed: May 29, 2018

(51) Int. Cl. G06Q 30/06; G06F 17/30; B44C 1/00

(52) U.S. Cl. CPC G06Q 30/0621; G06Q 30/0641; B44C 1/00; G06F 17/30244

(57) ABSTRACT

A custom door design system including a server; the server including a database storing a plurality of files, a software-application hosted on an electronic-device, and a communication-network communicably coupling the server and the electronic-device. The custom door design system provides means for generating customized door design specifications for fabricating a customized door design to install on a surface of a door. A method for generating customized door design specifications is also provided.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of mobile applications and websites and more specifically relates to design mobile applications and websites.

### 2. Description of Related Art

Many individuals planning to renovate or refurbish parts of their home have fairly firm ideas as to the features they feel are most important for the new design. Software applications exist which allow a user to create a preliminary plan themselves before seeking the help of a professional architect or designer. However, for the most part, these applications are difficult to use and require the user to be very specific in the placement of all structural features and fittings for the home without the benefit of professional guidance. A suitable solution is desired.

U.S. Pub. No. 2016/0086375 to Ravikiran Devaki relates to a system and method for three-dimensional reconstruction, measurement and visualization. The described system and method for three-dimensional reconstruction, measurement and visualization includes a system, method, and computer program products for window and door design. More particularly, a computer implemented system and method is described for three-dimensional reconstruction and transformation, measurement and three-dimensional visualization of any objects. In one aspect, a computer implemented system and method is described for three-dimensional reconstruction and transformation for automatic measurement and three-dimensional visualization so as to be able to measure dimensions of products from a photograph and visualize same.

### BRIEF SUMMARY OF THE INVENTION

In view of the foregoing disadvantages inherent in the known mobile applications and websites art, the present disclosure provides a novel custom door design system. The general purpose of the present disclosure, which will be described subsequently in greater detail, is to provide a software app and website that allows users to create their own customized doors.

A custom door design system is disclosed herein. The custom door design system includes a server, the server including a database storing a plurality of files, a software-application hosted on an electronic-device, and a communication-network communicably coupling the server and the electronic-device. The custom door design system provides means for generating customized door design specifications for fabricating a customized door design to install on a surface of a door.

A method for generating customized door design specifications is also disclosed herein. The method for generating customized door design specifications may comprise the steps of: providing a custom door design system including a server, the server including a database storing a plurality of files, a software-application hosted on an electronic-device, and a communication-network communicably coupling the server and the electronic-device; accessing the software-application on the electronic-device; creating customized door design specifications using the plurality of files and a plurality of layout tools; manufacturing a door design using the customized door design specifications; and applying the door design to a surface of a door.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a custom door design system, constructed and operative according to the teachings of the present disclosure.

FIG. 1 is a view of the custom door design system according to an embodiment of the disclosure.

FIG. 2 is a view of the custom door design system of FIG. 1, according to an embodiment of the present disclosure.

FIG. 3 is a view of the custom door design system of FIG. 1, according to an embodiment of the present disclosure.

FIG. 4 is a view of the custom door design system of FIG. 1, according to an embodiment of the present disclosure.

FIG. 5 is a flow diagram illustrating a method of use for the custom door design system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a mobile applications and websites and more particularly to a custom door design system as used to improve the efficiency in designing for customized doors.

Generally, the invention is a software application and website that allows users to create their own customized doors. The user can upload various pictures and images to the website or choose from stock images. Then this allows them to customize the layout and style of the door they are looking to create, using the software layout tools. Choose from a selection of standard door sizes and create their own unique door design, materials, colors, integrated lighting. The customer design is then used to create an automated process to fabricate the door using laser guided machinery that cuts the various images, paints and assembles the door to the customer's specifications. Therefore, creating a unique and personalized design.

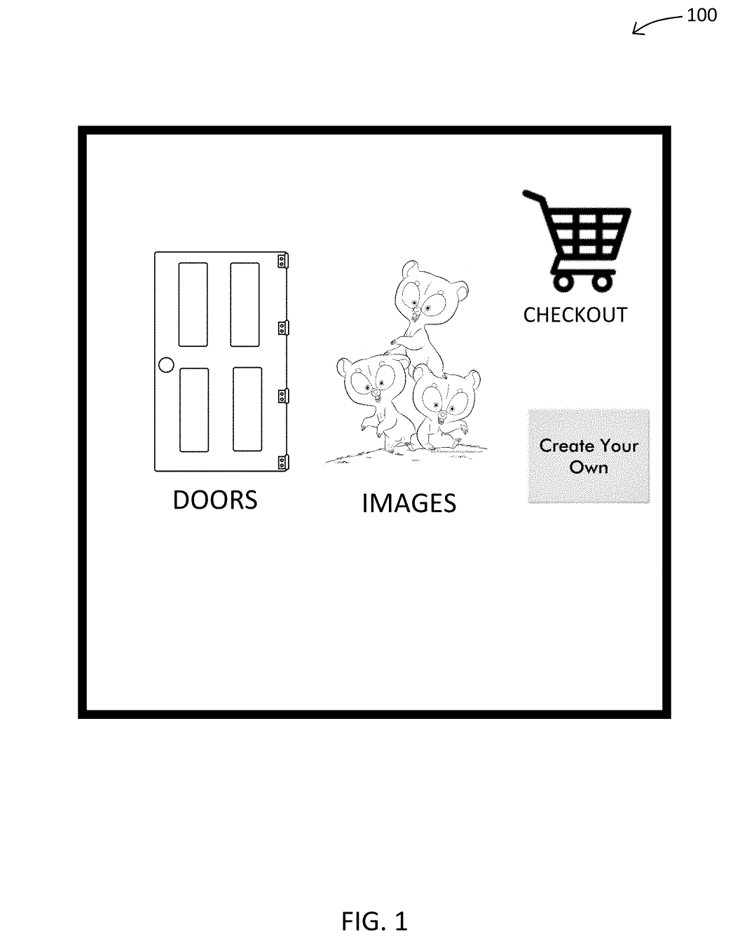

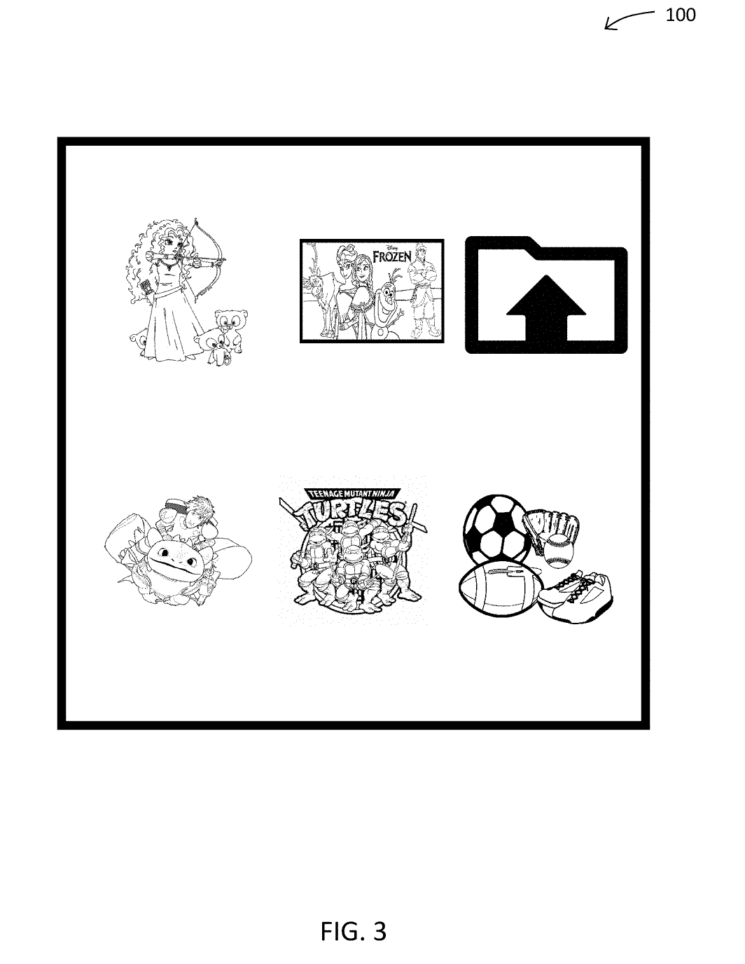

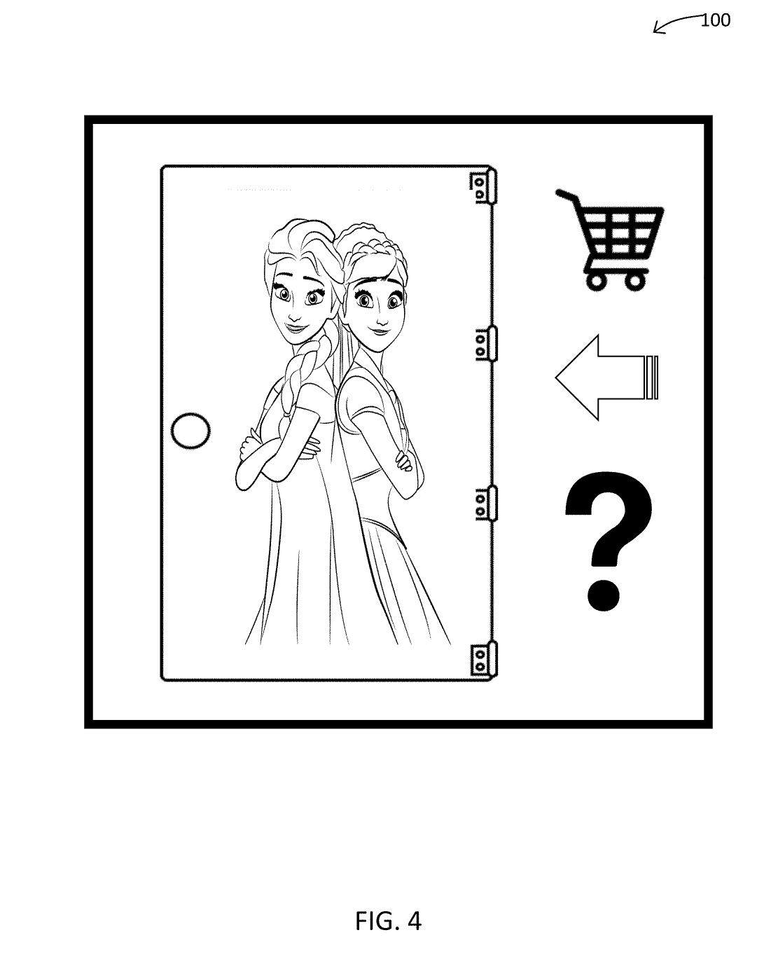

Referring now more specifically to the drawings by numerals of reference, there is shown in FIGS. 1-4, various views of a custom door design system 100. FIG. 1 shows a custom door design system 100 according to an embodiment of the present disclosure. As illustrated, the custom door design system 100 may include a server, the server including a database storing a plurality of files, a software-application hosted on an electronic-device, and a communication-network communicably coupling the server and the electronic-device. The custom door design system provides means for generating customized door design specifications for fabricating a customized door design to install on a surface of a door.

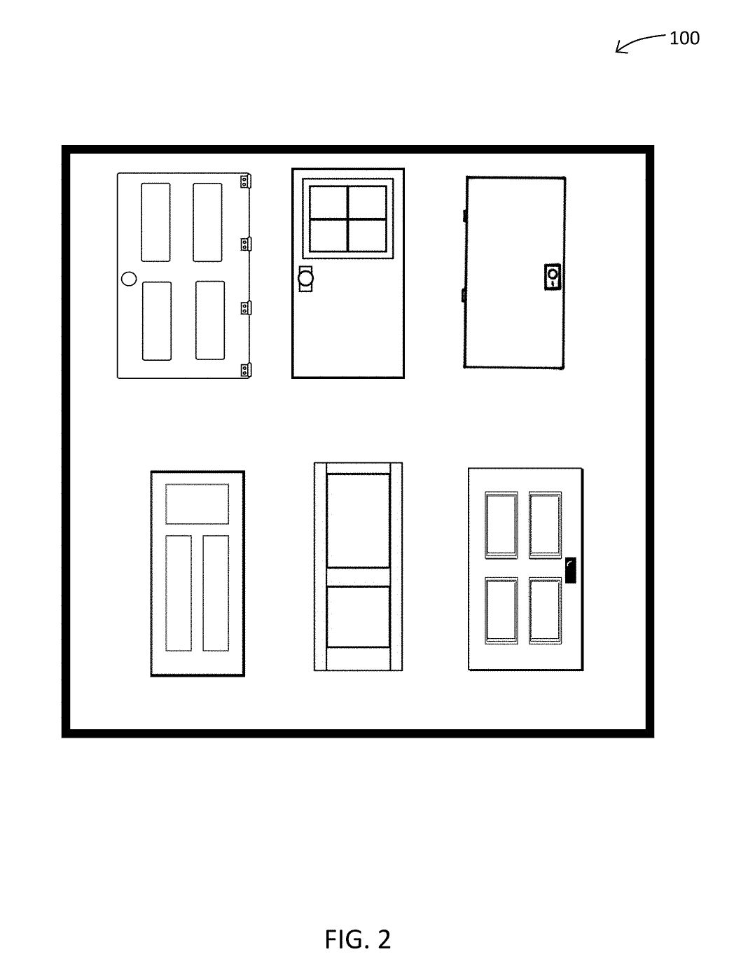

FIG. 2-4 show views of the custom door design system 100 of FIG. 1, according to an embodiment of the present disclosure. As above, the custom door design system 100 may include the server, the database storing the plurality of files, the software-application hosted on the electronic-device, and the communication-network communicably coupling the server and the electronic-device. The files include images. The images are configured to be uploaded to the database by a user and/or a plurality of stock-images stored on the database may be used. The software-application includes a plurality of layout tools for generating the customized door design specifications.

The customized door design specifications include optional integrated lighting. The customized door design specifications are fabricated using laser guided machinery for example. The software-application generates the customized door design specifications for fabricating and installing the customized door design having user-selected parameters. The software-application provides a visual representation of the door design on a display screen of the electronic-device.

The electronic-device may include a computer, tablet, and a mobile device. The software-application is downloadable onto the electronic-device or accessed via the internet on a website. The software-application includes specification input fields for generating a user-specified the design. The specification input fields include size measurements, color selections, material selections for fabrication, integrated lighting selections, and a series of other customizable options.

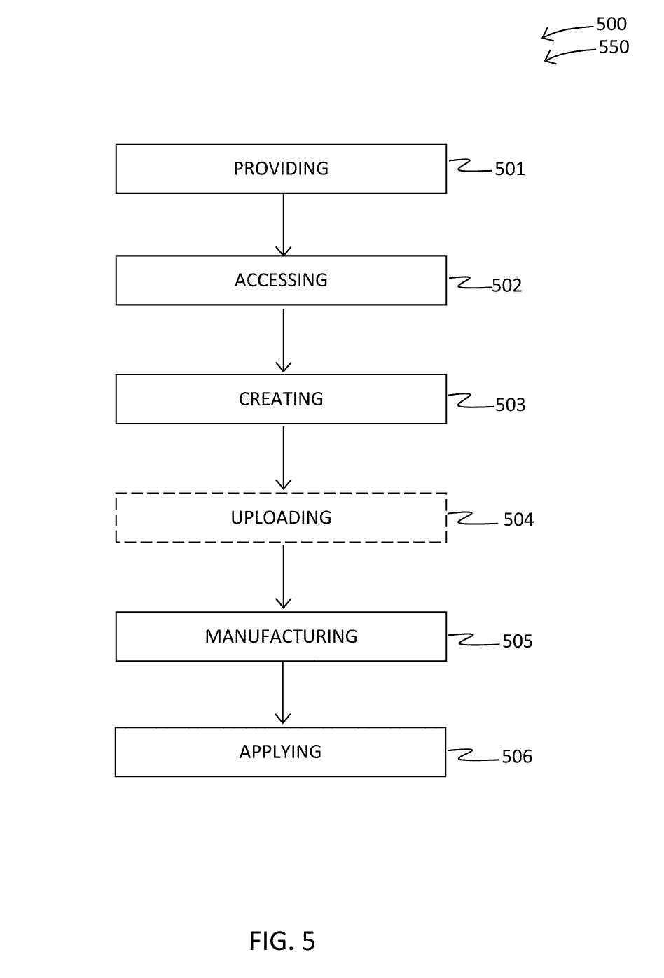

FIG. 5 is a flow diagram 550 illustrating a method for generating customized door design specifications 500, according to an embodiment of the present disclosure. As illustrated, the method for generating customized door design specifications 500 may include the steps of: step one 501, providing a custom door design system including a server, the server including a database storing a plurality of files, a software-application hosted on an electronic-device, and a communication-network communicably coupling the server and the electronic-device; step two 502, accessing the software-application on the electronic-device; step three 503, creating customized door design specifications using the plurality of files and a plurality of layout tools; step four 504, uploading an image to said database; step five 505, manufacturing a door design using the customized door design specifications; and step six 506, applying the door design to a surface of a door.

It should be noted that step four 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for custom door design system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A custom door design system comprising:
a server, the server including a database storing a plurality of files;
a software-application hosted on an electronic-device;
a communication-network communicably coupling the server and the electronic-device; and
wherein the custom door design system provides means for generating customized door design specifications for fabricating a customized door design to install on a surface of a door.

2. The custom door design system of claim 1, wherein said files include images.

3. The custom door design system of claim 2, wherein said images are configured to be uploaded to said database by a user.

4. The custom door design system of claim 2, wherein said database further stores a plurality of stock-images.

5. The custom door design system of claim 1, wherein said software-application includes a plurality of layout tools for generating said customized door design specifications.

6. The custom door design system of claim 1, wherein said customized door design specifications includes optional integrated lighting.

7. The custom door design system of claim 1, wherein said customized door design specifications are fabricated using laser guided machinery.

8. The custom door design system of claim 1, wherein said software-application generates said customized door design specifications for fabricating and installing said customized door design having user-selected parameters.

9. The custom door design system of claim 1, wherein said software-application provides a visual representation of said door design on a display screen of said electronic-device.

10. The custom door design system of claim 9, wherein said electronic-device is selected from the group consisting of a computer, tablet, and a mobile device.

11. The custom door design system of claim 1, wherein said software-application includes specification input fields for generating a user-specified said design.

12. The custom door design system of claim 11, wherein said specification input fields includes size measurements.

13. The custom door design system of claim 11, wherein said specification input fields includes color selections.

14. The custom door design system of claim 11, wherein said specification input fields includes material selections for fabrication.

15. The custom door design system of claim 11, wherein said specification input fields includes integrated lighting selections.

16. The custom door design system of claim 1, wherein said software-application is downloadable onto said electronic-device.

17. A custom door design system, the custom door design system comprising:
a server, the server including a database storing a plurality of files;
a software-application hosted on an electronic-device;
a communication-network communicably coupling the server and the electronic-device;
wherein the custom door design system provides means for generating customized door design specifications for fabricating a customized door design to install on a surface of a door;
wherein said files include images;
wherein said images are configured to be uploaded to said database by a user;
wherein said software-application includes a plurality of layout tools for generating said customized door design specifications;
wherein said customized door design specifications are fabricated using laser guided machinery;
wherein said software-application generates said customized door design specifications for fabricating and installing said customized door design having user-selected parameters;
wherein said software-application provides a visual representation of said door design on a display screen of said electronic-device;
wherein said electronic-device is selected from the group consisting of a computer, tablet, and a mobile device;
wherein said software-application includes specification input fields for generating a user-specified said design; and
wherein said software-application is downloadable onto said electronic-device.

18. A method for generating customized door design specifications, the method comprising the steps of:
providing a custom door design system including
a server, the server including a database storing a plurality of files;
a software-application hosted on an electronic-device; and
a communication-network communicably coupling the server and the electronic-device;
accessing said software-application on said electronic-device;
creating customized door design specifications using said plurality of files and a plurality of layout tools; and
manufacturing a door design using said customized door design specifications; and
applying said door design to a surface of a door.

19. The method of claim 18, further comprising the step of:
uploading an image to said database.
